(19) United States
(12) Patent Application Publication
(10) Pub. No.: US 2003/0209145 A1
(43) Pub. Date: Nov. 13, 2003

(54) Filtration device

(76) Inventor: Adrian John Soper, Cornwall (GB)

Correspondence Address: HOWREY SIMON ARNOLD & WHITE, CityPoint, One Ropemaker Street, London, EC2Y 9HS, GB

(21) Appl. No.: 10/119,900

(22) Filed: Apr. 11, 2002

(30) Foreign Application Priority Data
Feb. 14, 2002 (GB) GB 0203524.4

(51) Int. Cl. A62B 18/02

(52) U.S. Cl. 95/273; 128/201.18; 55/385.1

(57) ABSTRACT

A nasal filtration device adapted to remove minute particles from the air entering the nostrils, the device comprising a nasal insert adapted for insertion into a nostril of the user, the insert comprising a housing defining a passageway therethrough, a filter element disposed within the housing and extending across the passageway. The filter element comprises a filter membrane secured at its periphery to the interior surface of the housing, so as to provide a fluid-tight seal between the filter membrane and the inner surface of the housing. The filter diaphragm may be made of polypropylene fibres and the housing may be formed of rubber-modified polypropylene, ensuring enhanced bonding capability between the two components. A pair of inserts may be integrally formed with a connective member.

### BACKGROUND OF THE INVENTION

1. Field of the Invention

The present application relates to filtration devices, in particular to nasal filtration devices, and especially to devices for insertion into the nasal cavity to prevent foreign particles from being inhaled. Although reference is made to particles, the term is used in the present context to also include liquid droplets or aerosols.

2. Description of the Related Art

It is well known that many illnesses and complaints are caused by airborne particles entering the body by inhalation. The nose is equipped with its own filter system in the form of minute hairs or cilia, adapted to trap these particles and prevent their entry into the organism. This natural defence system is however unable to cope under all circumstances and the present invention seeks to provide an improved filter which supports the body's natural defences.

A particularly common illness is hay fever, which is caused by allergic reaction to particular pollen particles entering the body. It is estimated that in Great Britain alone more than 12 million people suffered from hay fever in 1999. For the United States, these figures may be expected to be proportionately higher and worldwide, the number of sufferers may be as many as 1 billion. Many sufferers resort to the use of medication, normally of the anti histamine variety, to suppress the effect of hay fever, but the use of drugs can have side effects such as drowsiness and persons using such medication may be excluded from driving or using machinery.

Other illnesses related to particle inhalation include asthma and emphysema. In large cities where atmospheric pollution is acute, the incidence of such illness is extremely high and steadily rising. In extreme cases, people are forced to use face-masks to reduce inhalation of particulate matter, such as are present in the exhaust gases emitted by motorised vehicles.

Bacteria and viruses can also be transmitted by inhalation. The risk of infection in this manner is particularly high in circumstances where many people are in close proximity, where there is a severe risk of transmission of communicable diseases such as influenza, tuberculosis, meningitis and the common cold.

A large number of devices have been proposed to prevent inhalation of airborne particles. These typically comprise two nasal inserts for insertion into the nasal cavity, each supporting a cylindrical wad-like filter element of cotton-wool or similar materials. Such devices are however extremely difficult to breathe through, since the pressure drop across the filter element is high. The user will therefore revert to breathing through the mouth, thus negating the benefits of using the proposed device. Such wads are also highly restrictive to breathing once they have taken up moisture, which is always present in the nasal cavity.

Other devices use membranes supported in annular peripheral frames. Such frames however provide insufficient stability to the device whereby the membranes may tilt within the nasal cavities allowing air to flow around the filter. Air by-passing the filter in this manner is clearly not filtered. Therefore, the user does not obtain the benefits of wearing the filter device.

n the field of medical care, filters are widely used to prevent the spread of infections in e.g. respiratory systems, air conditioning systems, infusion systems etc. The medical grade filter material used in these applications is however extremely costly and, as such, unsuitable for use in a mass-produced item for consumer sales.

Despite the many attempts to produce a workable design for a nasal filtration device, none of the prior art devices have overcome all of the above problems to achieve a design which not only functions effectively but is also comfortable to wear and which does not impede breathing. For this reason, many people continue to use face-mask filters, which are both unsightly and uncomfortable to wear. Only such large area face-masks have achieved the necessary breathing freedom with filter pore sizes sufficiently small to retain even the finest particles, while being able to guarantee an effective seal to prevent the ingress of unfiltered air into the nasal cavity of the wearer. Additionally, such large area face-masks require considerable quantities of expensive filter material and are thus relatively costly to manufacture. Disposal of the face-mask, after use, also presents a problem from an environmental stand-point.

Accordingly, there is a need for a device to allow air being inhaled to be filtered, that is simple, easy and inexpensive to manufacture and has an effective working life.

### BRIEF SUMMARY OF THE INVENTION

The present invention provides a significantly improved filter assembly, which is comfortable for the user to wear, provides an effective seal within the nasal cavity of the user, such that substantially all of the inhaled air is passed through the filter membrane and, once installed in the nasal cavities of a user, effectively filters substantially all of the particulate material in the air being inhaled. The advantageous design and selection of materials allow manufacturing techniques to be used, which are both highly cost-effective and also ensure the integrity of the assembly.

According to a first aspect of the present invention, there is provided a nasal filtration device for removing minute particles from the air entering the user's nostrils, the device comprising: a nasal insert adapted for insertion into a nostril of the user, the insert comprising a housing having an interior surface defining a passageway therethrough; and a filter element disposed within the housing and extending across the passageway, wherein the filter element is effective to prevent passage of particles greater than 1 micron in size.

According to a second aspect, the present invention provides a method of alleviating sickness by filtering particulate material from the air stream entering the nostrils by the use of a nasal filtration device effective to remove particles greater than 1 micron in size, the filtered particulate material being selected from the group consisting of pollen, house dust, bed mite faeces, bacteria, viruses, hair, dust, smoke, aerosols and spores.

According to a further aspect, the present invention provides a method for preventing inhalation of particulate material greater than 1 micron in size by use of a filter membrane comprising 3-ply polypropylene fibres, the membrane having a weight distribution of between 1.5 and 3.5 grams per square foot.

The filtration device of the present invention may provide relief for hay fever and asthma sufferers by preventing the inhalation through the nose of pollen and other irritant particulates, such as dust. Other uses of the device include the use at night to prevent asthma and allergy attacks due to bed mites and their faeces in pillows and bedding, and the use to filter out pet hairs which can cause asthma.

Accordingly, in a still further aspect, the present invention provides a method of preventing the onset in a patient of allergies caused by the inhalation of particulate contaminants in air being inhaled, the method comprising installing in each nasal cavity of the patient an insert as hereinbefore described.

In addition, the device can also prevent or reduce the transmission of airborne bacteria and viruses such as influenza and the common cold. Such devices could be used by travellers in vehicles, particularly on crowded trains and on airlines to avoid the transmission of contagious diseases. This application is considered revolutionary in this field as no other viral filtration system presently available is personalised or small enough to discreetly fit inside the nasal cavity.

Further, the present invention may also include the use of a device as hereinbefore described to alleviate snoring by the provision of a slight pressure drop through the nose while not causing the wearer to revert to breathing through the mouth; to prevent excessive nose-picking by not only obstructing the nose but also preventing build up of debris on the nasal cilia; to protect persons exposed to dusty or noxious environments; and to alleviate passive smoking in environments in which smokers gather, such as public houses, bars and clubs.

In a further development of the filter device of the present invention use can be made of the techniques developed in this device to reduce cross-contamination between patients in hospitals. It is a well-known and unfortunate fact that many hospital inpatients succumb to further infections due to their stay at a hospital or clinic. The increased presence of undesirable bacteria and viruses together with the patient's lowered resistance to disease make them particularly prone to infection. The use of such nasal filters or the inclusion of similar filter material in breathing lines and air-conditioning equipment could be extremely beneficial in reducing inpatient sickness. One embodiment of the device of the present invention comprises a retainer for retaining the end portion of a hose or tube within the housing of the insert. In this way, patients being supplied oxygen, by way of conventional hoses and tubes, may dispense with the conventional nose-clip retainer and employ an insert of the present invention to allow oxygen and filtered air to be inhaled.

### BRIEF DESCRIPTION OF THE DRAWINGS

The features and advantages of the invention will be appreciated upon reference to the following drawings, in which:

FIG. 1 is a perspective view of a filter device according to one embodiment of the present invention;

FIG. 2 is a cross-sectional view of the filtration device of FIG. 1;

FIG. 3 is a cross-sectional view of a further embodiment of the filter device of the present invention;

FIG. 4 is a perspective view of a filter device according to a further embodiment of the present invention;

FIG. 5 is a cross-sectional view of a filter device according to still a further embodiment of the present invention;

FIG. 6 is a plan view of the filter device of FIG. 5;

FIG. 7 is a plan view of an alternative device to that of FIG. 6; and

FIG. 8 is an autoradiograph obtained as a result of tests conducted on the filter device of FIG. 1 in the filtration of virus-size microorganisms

### DESCRIPTION OF ILLUSTRATIVE EMBODIMENTS

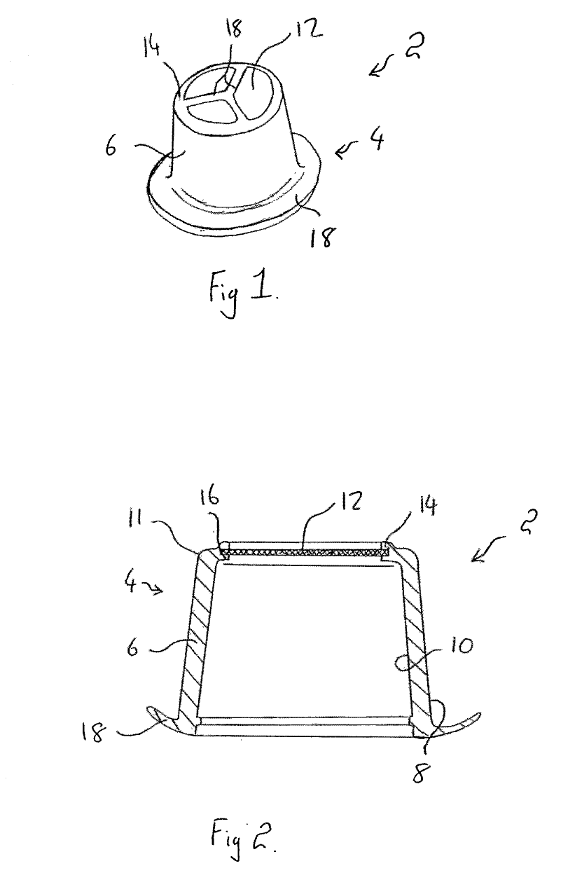

A filtration device according to a first embodiment of the present invention is shown in FIGS. 1 and 2. The device, generally indicated by the reference numeral 2, comprises a nasal insert, generally indicated as 4. The insert 4 comprises a housing 6 having an outer surface 8. The housing 8 has an opening at each end. The inner surface 7 of the housing 6 defines a passageway 10 through the housing, along which air or other gases may be caused to pass.

The housing 6 is shaped for insertion into a nostril of the user and is preferably shaped to allow it to seat comfortably within the nostril. Once the insert 4 is installed in this manner, the outer surface 8 of the housing 6 contacts the lining of the nasal cavity of the user and forms a seal between the outer surface and the lining. In this way, substantially all of the air being inhaled by the user through the nose is caused to pass through the passageway 10 within the housing 6. Preferably, the housing 6 is constructed with a wall thickness and of a material such that it is sufficiently soft and compliant to allow it to adapt to the shape of the nasal cavity of the user. In this way, the housing 6 is better able to form a seal between its outer surface 8 and the lining of the nasal cavity of the user and prevent air or other gases from passing through the nasal cavity and around the insert 4.

The housing 6 may be any suitable shape that is comfortable for the user to retain within the nose for an extended period of time and forms the required seal between the outer surface 10 of the housing 6 and the nasal lining. Preferably, the housing is generally cylindrical in shape. In the embodiment shown in FIGS. 1 and 2, the housing is slightly tapered or frusto-conical. This shape has been found to be particularly effective in ensuring that the insert 4 remains correctly located within the nasal cavity and helps to prevent it from tipping sideways whereby air being inhaled can bypass the insert. The housing 6 may alternatively be of a more complex shape to more completely match the nasal cavity ensuring greater comfort and may be made of a material which conforms to the inner surface of the nasal cavity once inserted therein.

The housing 6 is preferably formed with a rounded shoulder 11 at its end intended to be inserted into the nasal cavity of the user. This has been found to provide increased comfort for the user.

The housing 6 may be any suitable length, in order to provide a passageway extending up into the nasal cavity of the user, once the device 2 is installed in the nose. Most conveniently, the housing 6 has a diameter substantially the same as the nominal diameter of the nostril of the user. If the housing 6 is tapered, this diameter is that of the end of the housing intended to be outermost once the device is installed, with the housing tapering to a smaller diameter inwards within the nasal cavity. It is also convenient to have the length of the housing substantially the same as its maximum diameter. However, it will be appreciated that it is possible to have a housing that is longer or shorter, provided that a passageway is present within the housing extending up into the nasal cavity once the device is installed.

The insert 4 further comprises a filter element 12 extending across the passageway 10 within the housing 6. The filter element 12 is arranged within the housing 6, such that all the air or other gas being inhaled by the user is caused to pass through the filter element 12. A preferred arrangement is one in which the filter element extends across the passageway 10 substantially perpendicular to the intended direction of flow of the air or other gas through the passageway. However, it will be appreciated that other orientations of the filter element may also be employed and achieve the same result. In this respect, the filter element 12 may extend diagonally across the passageway 10 within the housing 6. The filter element 12 may be pleated or folded, in order to increase the overall surface area of the filter. Alternatively, the filter element 12 may be curved in one or two dimensions across the passageway 10, again in order to increase the surface area of the filter. It is an advantage of the device of the present invention that the filter element is thin, i.e. that it has a thickness in the intended direction of flow of air or gas through the filter element that is significantly smaller than the diameter of the passageway across which the filter element extends. This allows the air or gas to be inhaled by the user with little or no perceptible pressure drop across the filter element. Further, it allows the filter element to be secured at its periphery to the housing 6. In this respect, the filter element is secured within the housing by a form of mechanical or chemical bond, or a combination of the two, in order to create the requisite seal.

As shown in FIG. 2, the filter element 12 is disposed at one end of the housing, in this embodiment, the end of the housing to be located innermost within the nasal cavity of the user, once the insert 4 is properly installed. In this way, access to the interior of the housing 6 is maintained, once the insert 4 has been installed. This allows the housing 6 to be used to support other devices, such as gas tubes, as will be discussed hereinafter. However, it will be appreciated that the filter element 12 may be disposed at any point along the passageway 10 within the housing.

The embodiments shown in the accompanying figures have one filter element. It will also be appreciated that two or more filter elements, located either together or spaced apart along the passageway, may also be employed. One embodiment includes a fine filter element at an inward or downstream position of the passageway 10, when installed in the nose and the user is inhaling, with a coarser pre-filter element located outward or upstream thereof to reduce clogging.

According to the present invention, the filter element 12 is secured at its periphery to the interior surface 10 of the housing 6. This arrangement provides various functions. First, it ensures that the filter element 12 is retained out of contact with the interior surface of the nose, thereby reducing unwanted wetting of the filter element 12, thereby preventing the performance of the filter from becoming impaired due to saturation by liquid. Further, this arrangement also ensures that the filter element 12 is firmly held to prevent movement of its edges during breathing, which could cause air or other gas being inhaled to pass between the filter element 12 and the inner surface 10 of the housing 6. Finally, this arrangement also prevents possible complete inhalation of the filter element 12.

Referring to FIG. 2, the filter element 12 is retained between two flanges 14 and 16 extending inwardly from the end portion of the housing. As a further safeguard against possible inhalation of the filter element 12, supporting members 18 may be provided. As shown in FIG. 1, these members 18 extend across the passageway 10 at the end of the housing 6, such that they will be on the inner or downstream side of the filter element 12, when the insert is in place in a nostril and the user is inhaling. As indicated in FIG. 1, three radially-oriented supporting members 18 are provided in the embodiment shown. In order to reduce restriction to the air-flow through the inserts 4, these supporting members should be as small as possible. Alternative embodiments may use four or more members arranged in any practical configuration. In a further alternative these members may be omitted altogether.

The insert 4, including housing 6, may be of any suitable material that is safe for the user to have in contact with the lining of the nasal cavity. It is preferred that the entire insert is prepared from the same material and it is an advantage of the device of the present invention that this is possible. The insert 4 is preferably manufactured from medical grade plastics material. Suitable materials include elastomers, preferably thermoplastic elastomers (TPEs) and thermoplastic vulcanizites (TPVs). Rubber-modified polymers, such as rubber-modified polypropylene, are particularly suitable materials from which to form the housing or the entire insert. Santoprene™ a commercially available, high-performance rubber-modified polypropylene manufactured by Advanced Elastomer Systems, has been found highly suitable for this purpose. Silicon rubber and silicon rubber based composites may also be used. The aforementioned materials may be used either alone or in combination.

A key element of the nasal filter is the filter element 12. This is constructed from a filter material having fine pores, in order to ensure adequate entrapment of particles. Depending on the intended particles to be retained by the device (pollen, household dust, bacteria, viruses), the pore or mesh size may be selected accordingly. Preferably, the membrane should be effective to prevent passage of particles greater than 10 microns diameter. More preferably, the membrane should be effective to prevent passage of particles greater than 5 microns, perferably greater than 1 micron diameter. For complete protection against passage of all known viruses, the membrane should be effective to prevent passage of particles as small as 0.1 microns in diameter, preferably as small as 0.075 microns, and even as small as 0.05 microns in diameter. Any suitable material may be used to prepare the filter element. Plastic materials are particularly convenient. Polypropylene is particularly preferred. It is preferred that the material of the filter element is the same as or complementary with the material of construction of the housing and remaining components of the insert. This is particularly advantageous when securing the filter element within the housing, for example by means of adhesives or welding. The filter element may be a single layer of material, or may comprise mutliple layers or plies. The element may be woven or non-woven. The present invention contemplates the use of laminated membranes comprising differently oriented layers of the same material or comprising layers of different materials. A particularly suitable material for this purpose is HDC™ II-J100 manufactured by Pall Corporation. This is a polypropylene based non-woven, 3-ply membrane and is particularly advantageous in combination with an insert 4 of Santoprene™. It has a weight distribution of between 1.5 and 3.5 g/sq.ft. Other members of the HDC™ II-J series may also be selected depending upon the particle size to be retained. It is also considered that other materials including polyamide fibres, hydrophobic glass fibres, PTFE and modified acrylic copolymers such as Versapor™ manufactured by Pall Corporation may be suitable candidates for the membrane material. It is also envisaged that electro-static materials as used in high-quality vacuum systems could be used.

The filter element 12 is firmly secured at its periphery to the interior surface 7 of the housing 6 of the insert 4. This may be achieved by welding, glueing, encapsulation, mechanical fitting or any other suitable means. One particularly appropriate method is ultrasonic welding, whereby the filter element 12 is cold welded into place. Alternatively, full injection mould encapsulation using robotic technology may be used by placing a robotic feeder in the area of the injection mould machinery with full laser cutting of the filter element and full insertion by the robotic machinery into place within the mould tool. This process is known as “hot-running” and the liquid housing material is channelled around the filter element 12 at melt point and on cooling traps the filter element 12 within the solidity of the unit.

In the embodiment shown in FIGS. 1 and 2, the filtration device 2 comprises a flange 18 extending around the exterior of the housing 6 at the opposite end of the housing 6 to the filter element 12. The flange 18 serves to enlarge the overall diameter of the insert 4. In use, the insert 4 is placed within the nasal cavity of a user so that the flange 18 abuts the nostril and septum of the nose. In this way, the flange 18 acts as an obstacle preventing the filtration device 2 from completely entering the nasal cavity and becoming stuck or trapped. It will be appreciated that alternative arrangements to the flange 18 may be provided. Thus, referring to FIG. 3, a tab 20 is provided in place of the flange 18, extending from the outer surface 8 of the housing 6. Further alternative arrangements include a plurality of spaced tabs or other protuberances extending from the housing in the same or similar position as the tab 20 and the flange 18.

A most convenient and preferred embodiment of the present invention is shown in FIG. 4. In the embodiment of FIG. 4, two inserts 4 are joined by a narrow securing strip 22. The securing strip 22 both prevents the complete inhalation of the inserts 4 and aids extraction. The securing strip 22 can be made extendable or adjustable to allow for different spacings between nostrils, allowing the device to be fitted to a variety of users.

Both inserts 4 of the device of FIG. 4 can be formed in one piece, together with the securing strip and supporting members if present, preferably by injection moulding techniques. They may however be manufactured separately by injection moulding or by extrusion depending on the particular desired shape of the final product.

In order to cater for different sizes of user, the filter device 2 can be made available with housings 6 in a range of different sizes, from infant to large male, allowing also for the different anatomical characteristics of different ethnic groupings. The materials used for the inserts should generally be of neutral (skin colour) or transparent colouring for purposes of discretion. In certain circumstances however it may be desirable to use particularly bright or visible colourings and decorations.

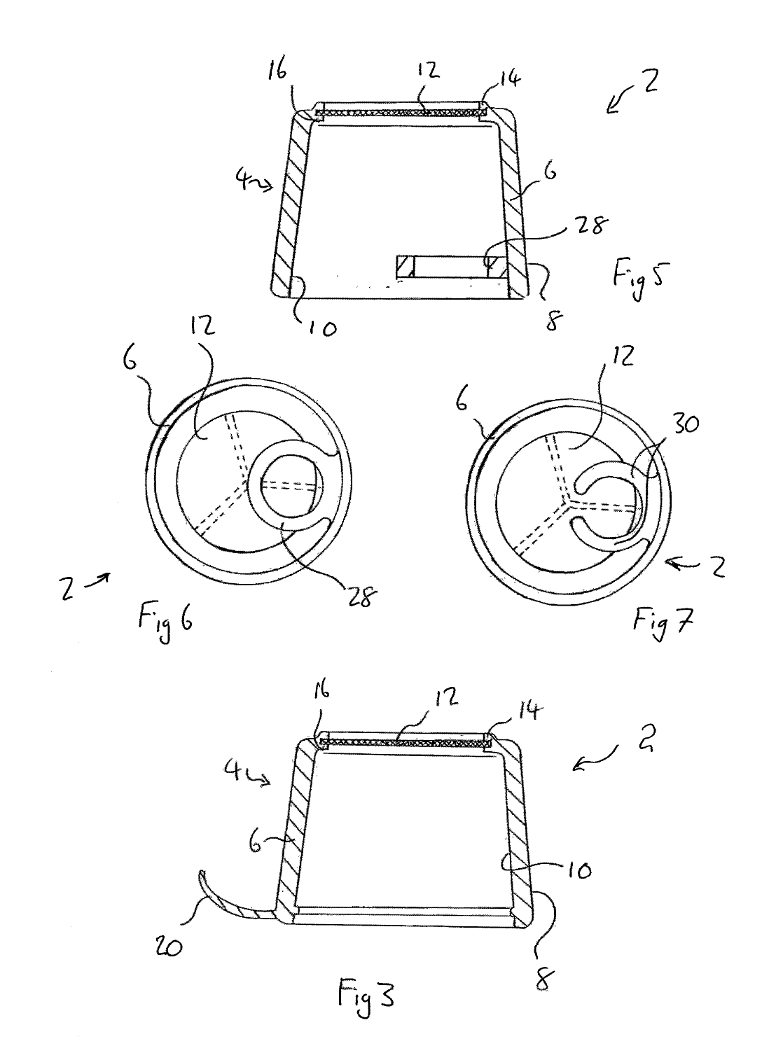

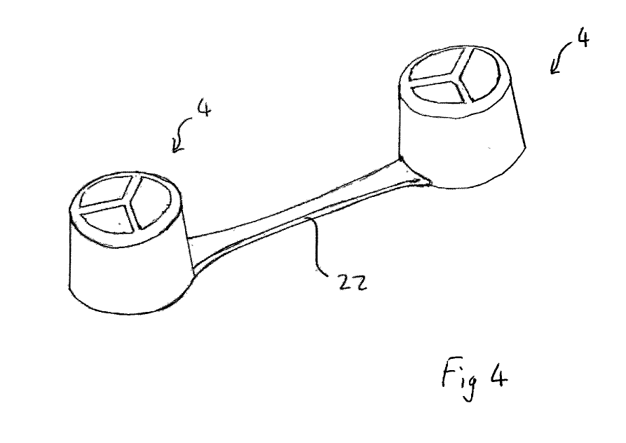

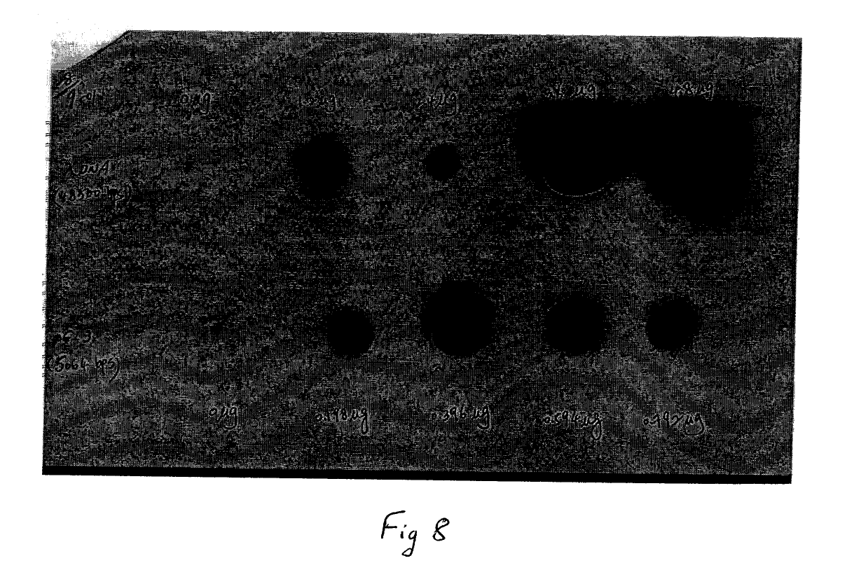

As mentioned hereinbefore, it is advantageous to position the filter element 12 at the innermost end of the housing 6, as viewed with the insert 4 in place in a nostril. This allows ready access to the interior of the housing 6 even with the insert in place in the user. Referring to FIGS. 5 and 6, there is shown a further embodiment of the filter device 2, in which a retaining ring 28 is disposed within the housing 6. The retaining ring 28 may be used to retain and support appliances, such as tubes for supplying gases, for example oxygen, to patients. One or a plurality of such retaining devices may be provided within the housing, according to need. FIG. 7 shows a further embodiment of this concept, in which the retaining ring 28 has been replaced by a pair of opposed retaining members 30 extending inwardly from the housing 6.

In use, filter device of the present invention is inserted in the nose of a user such that the insert 4 extends upwards into one nasal cavity, with the filter element inner most within the nose. The insert 4 is inserted until the obstruction, such as the flange 18, the tab 20 or the connecting strip 22, if present on the device, contacts one or both of the nostril or the septum of the nose. At this point the device is in place. A substantially gas-tight seal will have been formed between the outer surface of the housing and the lining of the nasal cavity. Small adjustments to the position of the insert within the nasal cavity may be made in order to improve the seal or to improve comfort.

An insert is installed in each nostril. Once installed, the user breathes normally through the nose, causing all inhaled air and gases to pass through the passageways of the inserts and through the filter elements. In general, the device will offer little to no obstruction to normal breathing. The user is advised to breathe as little as possible through the mouth, in order to minimise the amount of air or other gases by-passing the filter elements in the nose.

Once exposure to the contaminated air or gas has ended, the inserts may be removed. The inserts may be made integral with the remainder of the device, as mentioned above. In this case, the entire device is replaced, once the filter has been exhausted. Alternatively, the inserts may be made removable from the remainder of the device, such as the flange or securing strip. In such cases, the inserts only may be replaced and the device reused.

Referring again to the material of the filter element, it was a surprising discovery that the 3-ply polypropylene fibrous material employed in the present invention can filter particular material much smaller than pollen and dust particles. As noted, this material will allow particles as small as individual viruses to be trapped and retained. Accordingly, in a broader concept, the present invention also provides the use of the aforementioned material in the filtering from air and other gaseous streams viruses, bacteria and particles of like size.

The filtration device of the present invention has been subjected to extensive laboratory testing and has shown itself to be almost 100% effective in the removal of particles greater than 1 micron from air being inhaled by a user of the device. Most surprisingly, it has been found that it is possible for the user to have filtered from the inhaled air, particles much smaller than any naturally existing virus

The efficacy of the filtration device of the present invention will now be demonstrated by way of the following example.

### EXAMPLE 1

Experimental tests were conducted on the nasal filtration device of FIG. 1. The insert was prepared from Santoprene™, a rubber-modified polypropylene, available commercially from Advanced Elastomer Systems. The filter element was made from HDC™ II-J100, a multi-ply, polypropylene fibre material manufactured by Pall Corporation which has a weight distribution of between 1.5 and 3.5 g/sq.ft.

The filters were tested using two separate sources of viral DNA. A first source comprised PGL3, an artificially created virus consisting of 5000 base pairs, which is many orders of magnitude smaller than anything that exists in nature. A second source comprised Lambda DNA having approximately 48000 base pairs and which is still considerably smaller than any influenza virus.

The viral DNA sources were put into solution at a number of different concentrations and put into syringes with the nasal filtration device at one end. Pressure was applied to the syringe to force the solution through the filter.

DNA hybridisation was then undertaken on the filters using the southern block technique to radioactively label the sequences for plasmids and bacteriophage. This identified any viral DNA captured in the filter, which showed up as spots on an x-ray film. When the concentration of viral DNA was high in the solution, the pick. up was equally high in the filter. The results of the test together with the respective solution concentrations are illustrated in the autoradiograph of FIG. 8.

The tests showed that the nasal filtration device succesfully traps minute particles, many times smaller than viruses that exist in nature.

The embodiments described above are susceptible to various further modifications without departing from the spirit and scope of the invention. Accordingly, although specific embodiments have been described, these are examples only and are not limiting upon the scope of the invention.

What is claimed is:

1. A nasal filtration device for removing minute particles from the air entering the user's nostrils, the device comprising:
a nasal insert adapted for insertion into a nostril of the user, the insert comprising a
housing having an interior surface defining a passageway therethrough; and
a filter element disposed within the housing and extending across the passageway,
wherein the filter element is effective to prevent passage of particles greater than 1 micron in size.

2. The filtration device according to claim 1, wherein the outer surface of the housing is shaped to substantially match the shape of the inner surface of a nostril of the user.

3. The filtration device according to claim 1, wherein the housing is formed of a readily deformable material, capable of adopting the shape of the nasal cavity of the user, once inserted therein.

4. The filtration device according to claim 1, wherein the filter element is effective to prevent passage of particles greater than 0.5 micron in size.

5. The filtration device according to claim 1, wherein the filter element is secured around its periphery so as to provide a gas-tight seal between the filter element and the housing.

6. The filtration device according to claim 1, wherein the filter element is secured around its periphery to the interior surface of the housing by welding or by full injection mould encapsulation.

7. The filtration device according to claim 6, wherein the housing and the filter element are made of the same or complementary materials, which can be readily bonded or joined together.

8. The filtration device according to claim 1, wherein the filter element comprises polypropylene fibres.

9. The filtration device according to claim 1, wherein the filter housing comprises a rubber-modified elastomer.

10. The filtration device according to claim 1, further comprising retaining means serving to retain the insert at the desired position in the nose of the user and prevent its inhalation.

11. The filtration device according to claims 10, wherein the retaining means comprises an integrally formed tab or a flexible flange for seating against the underside of the user's nose.

12. The filtration device according to claim 1, further comprising a second nasal insert and a connecting member, the connecting member being connected to and extending between each nasal insert.

13. The filtration device according to claim 12, wherein the connecting member is flexible, such that it assumes a shape substantially corresponding to the nasal septum of the user, once each of the inserts is inserted in a respective nasal cavity of the user.

14. The filtration device according to claim 12, wherein the connecting member is adjustable in length.

15. The filtration device according to claim 1, wherein the insert comprises two or more filter elements spaced from each other in the direction of intended air flow.

16. The filtration device according to claim 15, wherein the two or more filter elements have different pore sizes.

17. The filtration device according to claim 1, wherein the filter element is arranged diagonally within the passageway.

18. The filtration device according to claim 1, wherein the filter element is pleated or folded to increase its overall surface area.

19. A method of alleviating sickness by filtering particulate material from the air stream entering the nostrils by the use of a nasal filtration device according to claim 1, the filtered particulate material being selected from the group consisting of pollen, house dust, bed mite faeces, bacteria, viruses, hair, dust, smoke, aerosols and spores.

20. A method for preventing inhalation of particulate material greater than 1 micron in size by use of a filter membrane comprising 3-ply polypropylene fibres, the membrane having a weight distribution of between 1.5 and 3.5 grams per square foot.
